(19) United States
(12) Patent Application Publication
(10) Pub. No.: US 2003/0231493 A1
(43) Pub. Date: Dec. 18, 2003

(54) Decorative lamp

(76) Inventor: Han-Ming Lee, Taipei City (TW)

Correspondence Address: HAN-MING LEE, P.O. BO 7-820, TAIPEI, TW

(21) Appl. No.: 10/172,883

(22) Filed: Jun. 18, 2002

(51) Int. Cl. H01R 33/00

(52) U.S. Cl. 362/226; 362/806

(57) ABSTRACT

A unit lamp of a string of decorative lamps comprises a base having a fastening arrangement; a cylindrical socket having a mated fastening arrangement; and two U-shaped conductor sections each having a conformed shape. After the conductor sections have electrically coupled to a bulb, fasten the base and the socket for securing the conductor sections to the socket.

### BACKGROUND OF THE INVENTION

1. Field of the Invention

The present invention relates to decorative lamps and more particularly to one lamp unit of a string of decorative lamps with improved characteristics.

2. Description of the Prior Art

A conventional process of manufacturing one lamp unit of a string of decorative lamps (e.g., one used for Christmas decoration) comprises the step of attaching one ends of two bare conductors to pins of a bulb by snapping. However, such securing is not reliable since there is no additional fastening by, for example, a base. Thus, it tends to be disconnected or even cause sparks. Thus improvement exists.

### SUMMARY OF THE INVENTION

It is therefore an object of the present invention to provide a decorative lamp comprising a bulb; a base including a top inverted T-shaped block, two opposite L-shaped first grooves on two sides, two half circular first troughs each perpendicular to a horizontal section of the L-shaped first groove, and two opposite arc flanges each along a periphery of a bottom; a cylindrical socket including an upper opening, a lower opening having two side passageways, an intermediate channel communicated with both the upper and lower openings, two vertical grooves on both sides of the channel also communicated with both the upper and lower openings, two opposite L-shaped second grooves on an inner wall of the lower opening, two half circular second troughs each perpendicular to a horizontal section of the L-shaped second groove, and two opposite arc projections along a periphery of a bottom; and two U-shaped conductor sections each including two slip-resistant enlargements each adjacent a bent portion, two bare bent members, and two terminals each on a top of the bent member. In assembly, the bulb is placed into the upper opening, one ends of the conductor sections are inserted into the lower opening through the passageways with the terminals in contact with pins of the bulb for electrical connection, upper half portions of the enlargements received in the half circular second troughs, and one halves of the bent members received in the L-shaped second grooves, and the base is snapped into the lower opening with the arc flanges secured to the arc projections, lower half portions of the enlargements received in the half circular first troughs, and the other halves of the bent members received in the L-shaped second grooves, thereby securing the conductor sections to the socket.

In one aspect of the present invention, the channel has a rectangular cross-section.

In another aspect of the present invention, the channel has a circular cross-section.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of one of a string of decorative lamps according to the invention;

FIG. 2 is an exploded view of the lamp of FIG. 1;

FIG. 3 is a view similar to FIG. 2 but showing the half-assembled lamp;

FIG. 4 is a view of a second preferred embodiment of a decorative lamp according to the invention; and

FIG. 5 consists of two cross-sectional views of the assembled lamp of either preferred embodiment.

### DETAILED DESCRIPTION OF THE PREFERRED EMBODIMENT

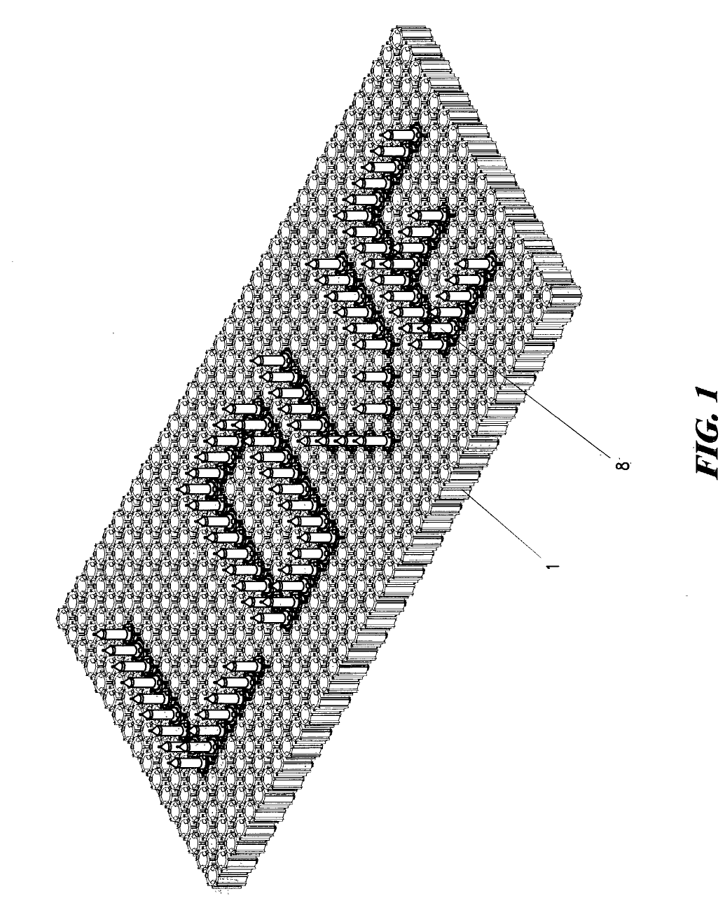

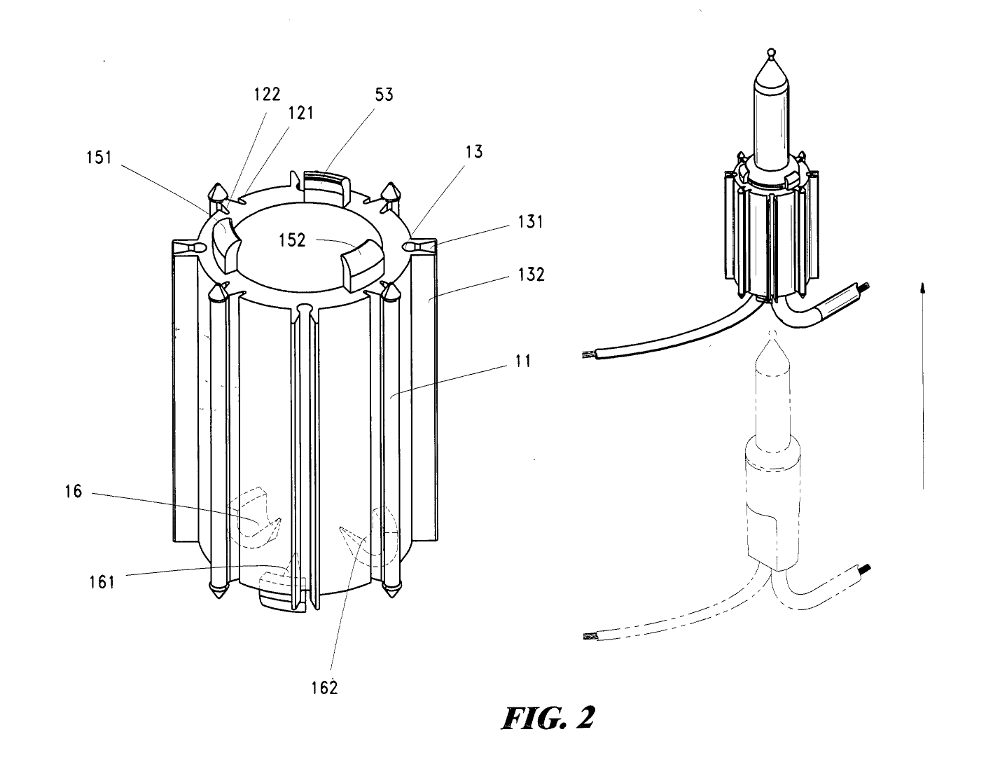

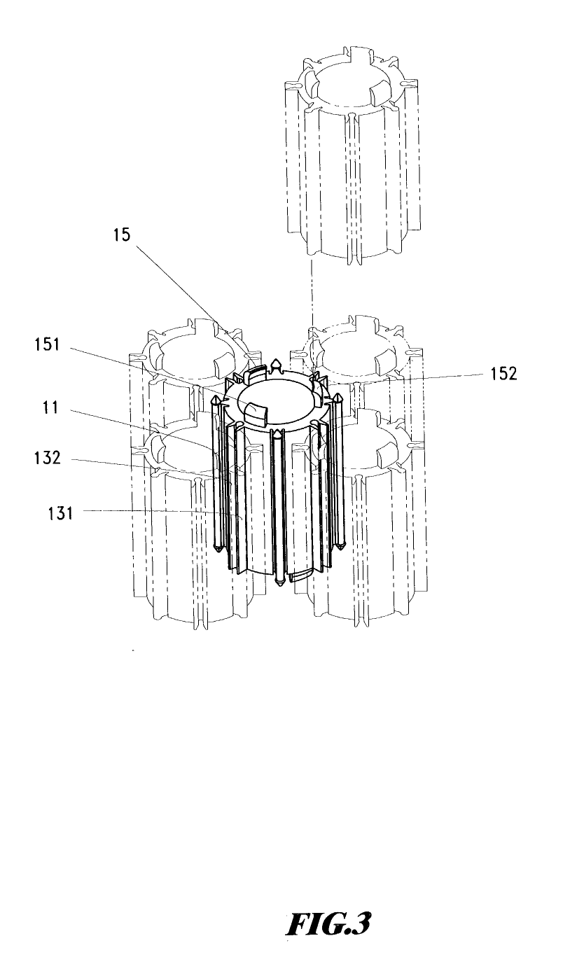

With reference to the drawings and in particular to FIGS. 1 to 4, there is shown a lamp constructed in accordance with the invention comprising a socket 1 and a bulb 8 such as LED (Light Emitting Diode) of bullet shape and having a lower enlargement.

Referring to FIGS. 1, 2, 3, and 5, there is shown a decorative lamp constructed in accordance with the invention comprising a bulb, a socket 6, a base 5, and two conductor sections 9. Each of above components will now be described in detail below except the bulb (unnumbered) since it is not the subject of the invention.

The base 5 comprises an inverted T-shaped block 51 on top, two opposite L-shaped grooves 52 and 522 on two sides, two half circular grooves 53 and 533 each perpendicular to a horizontal section of each of the L-shaped grooves 52 and 522, and two opposite arc flanges 55 and 555 each along a periphery of the bottom. The socket 6 is of cylindrical shape and comprises an upper opening 61, a lower opening 65 having two side passageways, an intermediate channel 62 of rectangular cross-section communicated with both the upper and lower openings, two vertical grooves 63 and 633 on both sides of the channel 62 also communicated with both the upper and lower openings, two opposite L-shaped grooves 66 and 666 on an inner wall of the lower opening 65, two half circular grooves 67 and 677 each perpendicular to a horizontal section of each of the L-shaped grooves 67 and 677, and two opposite arc projections 68 and 688 along a periphery of the bottom. Each of the conductor sections 9 is shaped like a U and comprises two slip-resistant enlargements 91 each adjacent a bent portion, two bare bent members 92, and two terminals 93 each on top of the bent member 92.

In assembly, first place the bulb into the upper opening 61. Next, mount one ends of the conductor sections 9 into the lower opening 65 through the passageways with the terminals 93 in contact with pins of the bulb for electrical connection, upper half portions of the enlargements 91 received in the half circular grooves 67 and 677, and one halves of the bent members 92 received in the L-shaped grooves 66 and 666. Note that the other ends of the conductor sections 9 are electrically connected to adjacent lamps of the string of the decorative lamp. Finally, snap the base 5 into the lower opening 65 with the arc flanges 55 and 555 secured to the arc projections 68 and 688, lower half portions of the enlargements 91 received in the half circular grooves 53 and 533, and the other halves of the bent members 92 received in the L-shaped grooves 52 and 522. As a result, the conductor sections 9 are secured to the socket 6.

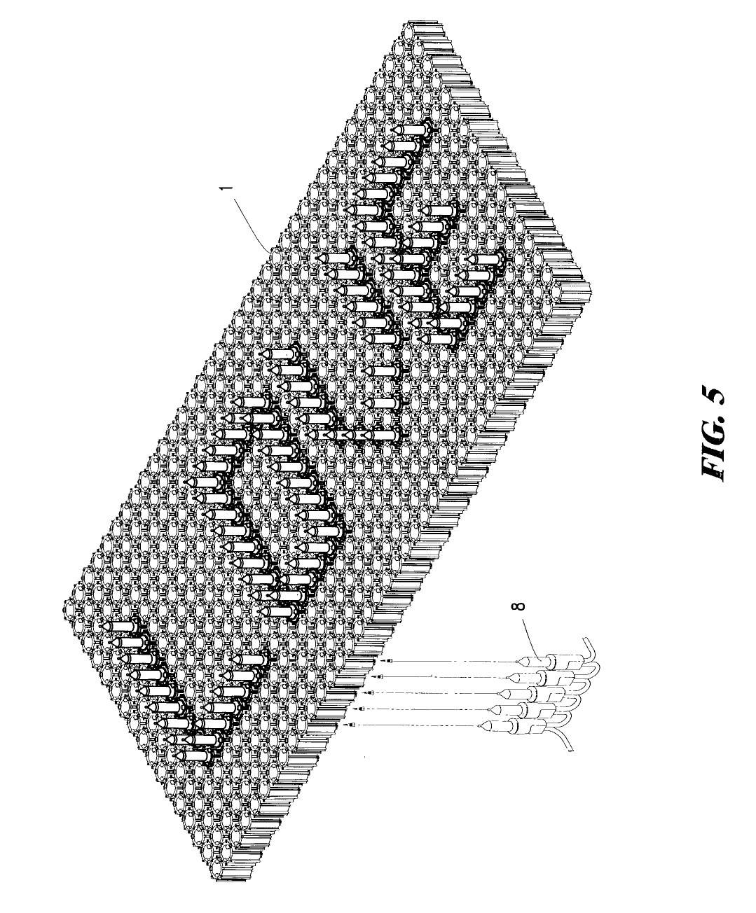

Referring to FIG. 5, further, a plurality of lamp units may be assembled together by securing the ridge sections of one lamp unit to the groove sections of two, three, or four adjacent lamp units (i.e., the ridges 11 fastened in the grooves 13 and the ribs 131 and 132 fastened in the side troughs 121 and 122 respectively). This forms a decorative lamp assembly. As shown, a word “LOVE” is arranged by the plurality of lamp units.

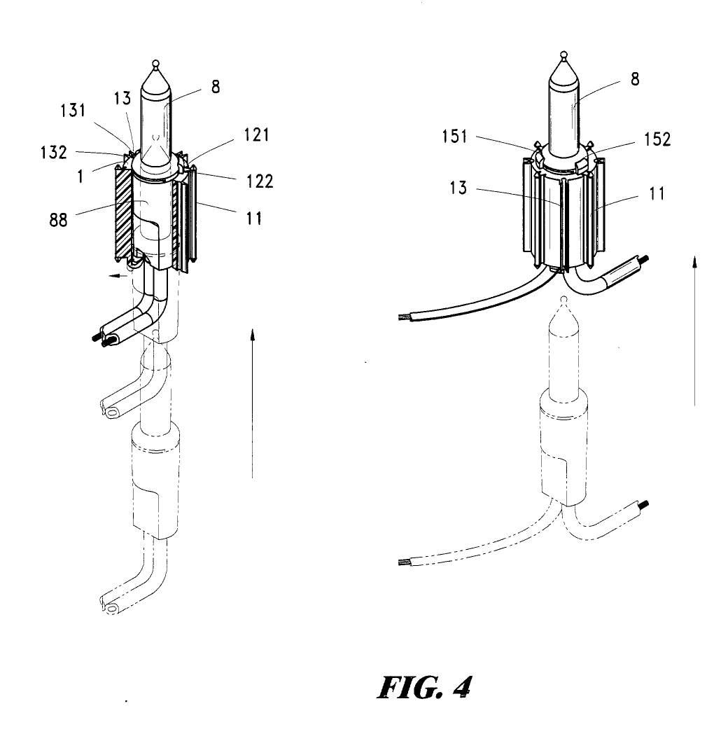

Referring to FIG. 4, there is shown a second preferred embodiment of a decorative lamp according to the invention. The difference between the first and the second preferred embodiments is the socket 6 which in the second preferred embodiment has an intermediate channel of circular cross-section and two vertical grooves wider than the vertical grooves 63 and 633.

While the invention has been described by means of specific embodiments, numerous modifications and variations could be made thereto by those skilled in the art without departing from the scope and spirit of the invention set forth in the claims.

What is claimed is:

1. A decorative lamp comprising:
a bulb;
a base including a top inverted T-shaped block, two opposite L-shaped first grooves on two sides, two half circular first troughs each perpendicular to a horizontal section of the L-shaped first groove, and two opposite arc flanges each along a periphery of a bottom;
a cylindrical socket including an upper opening, a lower opening having two side passageways, an intermediate channel communicated with both the upper and lower openings, two vertical grooves on both sides of the channel also communicated with both the upper and lower openings, two opposite L-shaped second grooves on an inner wall of the lower opening, two half circular second troughs each perpendicular to a horizontal section of the L-shaped second groove, and two opposite arc projections along a periphery of a bottom; and
two U-shaped conductor sections each including two slip-resistant enlargements each adjacent a bent portion, two bare bent members, and two terminals each on a top of the bent member;
Wherein in assembly, the bulb is placed into the upper opening, one ends of the conductor sections are inserted into the lower opening through the passageways with the terminals in contact with pins of the bulb for electrical connection, upper half portions of the enlargements received in the half circular second troughs, and one halves of the bent members received in the L-shaped second grooves, and the base is snapped into the lower opening with the arc flanges secured to the arc projections, lower half portions of the enlargements received in the half circular first troughs, and the other halves of the bent members received in the L-shaped second grooves, thereby securing the conductor sections to the socket.

2. A decorative lamp according to claim 1, wherein the channel has a rectangular cross-section.

3. A decorative lamp according to claim 1, wherein the channel has a circular cross-section.
